(19) United States
(12) Patent Application Publication
(10) Pub. No.: US 2004/0070482 A1
(43) Pub. Date: Apr. 15, 2004

(54) Flat coil

(76) Inventor: Gady Golan, Tel Aviv (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/466,932

(22) PCT Filed: Jan. 22, 2002
(86) PCT No.: PCT/IL02/00058

(30) Foreign Application Priority Data
Jan. 22, 2001 (US) 60263318

(51) Int. Cl. H01F 5/00

(52) U.S. Cl. 336/223

(57) ABSTRACT

A flat coil assembly (10) comprising at least one electrically conductive layer (12) arranged in a substantially uniplanar spiral arrangement of loops with a void in a center of the spiral, and a core (14) made from mu-metal, wherein the core extending on one side of the uniplanar spiral arrangement over at least a first portion of the loops from an external loop to an internal loop, crossing over, through the void in the center and extending over at least a second portion of the loops on the other side of the uniplanar spiral arrangement.

### FIELD OF THE INVENTION

The present invention relates to coils. More particularly it relates to a flat coil design yielding high inductance.

### BACKGROUND OF THE INVENTION

A coil usually consists of a spiral, solenoid, or inverted conical coil of wire. Large diameter wire, is used to keep the resistance of the coil low. Inverted conical (or ‘Saucer’) shaped coils have a slope of fifteen to thirty degrees. Flat spiral coils usually have an internal diameter that is ten times larger than the hole in its center.

A flat spiral coil is formed of a flat conducting ‘ribbon’ on top a printed circuit that is wound into a spiral.

The inductance of this type of flat coil is given by:

$$L = \frac{{a}^{2} \times {n}^{2}}{8 a + 11 w}$$

where:

L=Inductance in μHy.

a=average radius in inches as measured from the central axis to the middle of the winding.

n=Number of turns in the winding.

w=Width of the coil in inches.

A printed flat coil usually consists of a spiral wire winding. Large diameter wire is used in order to keep the resistance of the coil low enough at the operating frequency. Flat spiral coil usually has an internal diameter that is one tenth or so than the outer diameter (i.e. a 1 cm outer diameter and a 1 mm internal hole).

An object of the present invention is to provide a method of producing high permeability, high inductance, spirally printed flat coils that may be used for various applications requiring flat coils, such as in DC to DC converters or transmitting applications applicable in thin smart card applications.

### BRIEF DESCRIPTION OF THE INVENTION

It is therefore thus provided, in accordance with a preferred embodiment of the present invention, a flat coil assembly comprising at least oner electrically conductive layer arranged in a substantially uniplanar spiral arrangement of loops with a void in a center of the spiral, and a core made from mu-metal.

Furthermore, in accordance with a preferred embodiment of the present invention, there is provided a flat coil assembly comprising at least one electrically conductive layer arranged in a substantially uniplanar spiral arrangement of loops with a void in a center of the spiral, and a core layer made from mu-metal extending on one side of the uniplanar spiral arrangement over at least a first portion of the loops from an external loop to an internal loop, crossing over, through the void in the center and extending over at least a second portion of the loops on the other side of the uniplanar spiral arrangement.

Furthermore, in accordance with a preferred embodiment of the present invention, the first and second portions substantially overlap.

Furthermore, in accordance with a preferred embodiment of the present invention, the first and second portions substantially do not overlap.

Furthermore, in accordance with a preferred embodiment of the present invention, there are a first and second electrically conductive layers arranged each in a substantially uniplanar spiral arrangement of loops and electrically connected at internal ends of the spirals, and hjaving a void in a center of each of the spirals, and a core layer made from mu-metal extending on one side of the first uniplanar spiral arrangement over at least a first portion of the loops from an external loop to an internal loop, crossing over, through the voids in the center and extending over at least a second portion of the loops on the other side of the second uniplanar spiral arrangement.

Furthermore, in accordance with a preferred embodiment of the present invention, the electrically conductive layers are counteroriented.

Furthermore, in accordance with a preferred embodiment of the present invention, each electrically conductive layer is placed on either side of a dielectric layer.

Furthermore, in accordance with a preferred embodiment of the present invention, the core layer and the electrically conductive layer are about 100 microns in thickness each.

Furthermore, in accordance with a preferred embodiment of the present invention, the electrically conductive layer is made form copper.

Furthermore, in accordance with a preferred embodiment of the present invention,the layers are printed on a printed circuit board (PCB).

Furthermore, in accordance with a preferred embodiment of the present invention, the layers are manufactured using thick film technology, such as electroplating, metal-organic chemical vapor deposition (CVD).

Furthermore, in accordance with a preferred embodiment of the present invention, the layers are manufactured using thin film technology such as magnetron sputtering.

Furthermore, in accordance with a preferred embodiment of the present invention, the layers are manufactured using cut foils of mu-metal.

Furthermore, in accordance with a preferred embodiment of the present invention, the loops are rectangularly shaped.

Furth rmor, in accordance with a preferred embodiment of the present invention, the loops are flatly shaped.

### BRIEF DESCRIPTION OF THE FIGURES

In order to better understand the present invention, and appreciate its practical applications, the following Figures are provided and referenced hereafter. It should be noted that the Figures are given as examples only and in no way limit the scope of the invention as defined in the appending claims. Like components are denoted by like reference numerals.

FIG. 1 illustrates a frontal view of a flat coil in accordance with a preferred embodiment of the present invention.

FIG. 2 illustrates a view of the coil shown in FIG. 1 provided in isometry.

FIG. 3 illustrates a sectional view of a flat coil in accordance with another preferred embodiment of the present invention.

FIG. 4 illustrates a sectional view of another preferred embodiment of a flat coil in accordance with the present invention.

### DETAILED DESCRIPTION OF THE INVENTION AND FIGURES

Following are inductance calculations and approximation techniques for air-core coil structures. Included in this discussion are inductance calculations for: polygons, disk coils, finite-length solenoids and flat planar spirals.

Inductance calculation references necessarily start with Maxwell's seminal work, first published in 1873. Maxwell worked out some interesting inductance problems, including finding the mutual inductance between circular coaxial filaments, and finding the size and shape of a coil, which maximizes inductance for a given length of wire.

Methods of calculation inductance are well known in the art and may be studied from such references as the Radio Engineer Handbook and others. Circular wire loop: There is no closed-form solution for the inductance of a filamentary loop (since the expression for inductance becomes irregular if the wire radius goes to zero). A circular loop of round wire with loop radius a and wire radius R has the following approximate low frequency inductance:

$$L = {μ}_{o} a [ ln ( \frac{8 a}{R} ) - 1.75 ]$$

Using this equation, the inductance of a 1 meter circumference loop of 14 gauge wire is 1.12 mH; for 16 gauge wire it's 1.17 mH; and for 18 gauge wire it's 1.21 mH. Note the weak dependence of inductance on wire diameter, due to the natural log in the expression.

Parallel—wire line: For two parallel wires whose length l is high compared to their distance d apart, the inductance of the loop is:

$$L = \frac{{μ}_{o} l}{π} ln [ \frac{d}{R} + \frac{1}{4} - \frac{d}{l} ]$$

For I=0.5 meter and a wire-to-wire spacing d=1 cm, results are: L=0.505 mH for 14 gauge; L=0.551 mH for 16 gauge, and L=0.598 mH for 18 gauge. Therefore, for the parallel-wire line with closely-spaced conductors, the inductance is approximately 0.5 mH/meter of the total wire length.

Square loop: The self inductance of a square coil made of rectangular wire, with depth b transverse to the coil's surface small compared to the side length D and trace width 2 w is a complicated expression found in the Zahn reference. However, for w<<D a relatively simple expression can be approximated by:

$$L \approx \frac{2 {μ}_{o} D}{π} [ {sinh}^{- 1} ( \frac{D}{w} ) - 1 ]$$

For instance, a square printed circuit board trace of 1cm×1cm with trace width of 1 mm has an inductance of approximately 16 nH (assuming that the ground plane is 10 cm further).

Disk coil: A useful geometry for which tabulated results exist is the round loop with rectangular cross section, with mean radius a, axial thickness b, and trace width c. The self-inductance of this single loop is calculated using techniques outlined in Grover, where the inductance is shown to be:

$$L = \frac{25 {μ}_{o}}{π} a PF$$

This result is in MKS units, with a in meters and L in Henries. P and F are unitless constants; P is a function of the coil normalized radial thickness c/2a and applies to a coil of zero axial thickness (b=0), and F accounts for the finite axial length of the coil. For b<<c and c<<a (coils resembling thin disks) the factor F at 1, an important limiting case. Therefore, for a thin disk coil with doubling the mean radius, a corresponding doubling of the inductance is obtained. If the coil is made of multiple turns of wire, and if c<<a the inductance can be approximated by multiplying the above expression by N2. For this disk coil geometry, the inductance L is approximately proportional to a as shown above. The resistance of the coil is proportional to a/bc, the ratio of current path length to coil cross-sectional area. Therefore, the ratio of inductance to resistance is proportional to bc, or the cross-sectional area of the coil.

“Brooks” coil: An interesting problem is to maximize the inductance with a given length of wire. Maxwell found that th optimal coil has a square cross section with mean diameter 3.7 times the dimension of th squar cross section, or 2a=3.7c. Brooks and others, later refined this estimate and recommend 2a/c=3 as the optimum shape, with b=c. The result for the Brooks coil is:

L=1.353μₒaN²

The inductance is a rather weak function of 2a/c so the exact geometry isn't that important.

Round Planar Spirals: Planar spiral coils have increasing application in miniature power electronics and in PC-board RF inductors. A number of methods are available for the calculation of the inductance of a round spiral coil. Using the Grover method we find:

$$L = \frac{25 {μ}_{o}}{π} a {PN}^{2}$$

Where a is the mean coil diameter in meters and P is the factor depending on c/2a, as stated before. This equation is applicable if the inner and outer radii of the coil are not too different. For a circular coil with outer radius Ro and number of turns N, Schieber gives:

L=1.748×10⁻⁵μₒπRₒN²

Where Ro is in meters and L is in Henries. This equation is suitable if windings are used over the entire area. Another expression for L given by Wheeler:

$$L = 31.33 {μ}_{o} {N}^{2} \frac{{a}^{2}}{8 a + 11 c}$$

Where a is the coil mean radius, and c is the thickness of the winding. Wheeler states that the formula is correct to within 5% for coils with c>2a.

Errors occur when there are few turns, or if the spacing between the turns is too high. For a spiral coil with outer radius Ro=0.125 in and inner radius Ri=0, with N=5 calculation from the Grover method gives L at 55 nH, the Schieber method gives L at 55 nH and the Wheeler formula gives L at 67 nH. It appears that the Wheeler formula is more accurate.

Planar Square Coil: For the square coil, the effects of mutual coupling are not as simple to calculate as for the spiral case and the inductance is more difficult to calculate analytically. An empirical approximation for an N-turn square spiral is given. It is also reported that a ratio of D/Di of 5 optimizes the Q (quality factor) of the coil.

The inductance L of this coil is calculated using the following equation:

$$L = \frac{{N}^{2} {R}^{2}}{8 R + 11 W} \qquad 1$$

Here, the inductance L is given in micro Henry, N is the number of turns, W is the winding width and R is the average radius of the coil. Values of W and R are in inches.

As mentioned above, the inductance equation suits air-core coils, without a metallic core material. In order to increase the inductance of the coil while keeping the constant parameters: N, R, W, a use of a magnetic material as a core of the coil is needed. Using such a core, the inductance increase 1 times (μ is the magnetic permeability of the core material accordingly to equation 2):

L_{μ}=μL 2

Measurements of the magnetic properties of different core materials is complicated. A common method for magnetic permeability measurement is still un-known. The basic problem is in the significant role of the core material shape in such a measurement. However, relative measurement methods are well known. Our relative evaluation was done for different metallic materials of different shapes using a simple relay device, as the valuated material was placed in the free spac of the magn tic circuit and varied the obtained inductance of the relay d vice.

The present invention introduces a novel concept—providing flat coils with a core made from mu-metals.

Mu-metal is a nickel-iron alloy (comprising 72-80%—usually 77%—Ni (Nickel), 15% Fe (Iron), plus Cu (Copper) and Mo (Molybdenum) that is very efficient for screening magnetic fields and widely used for that purpose.

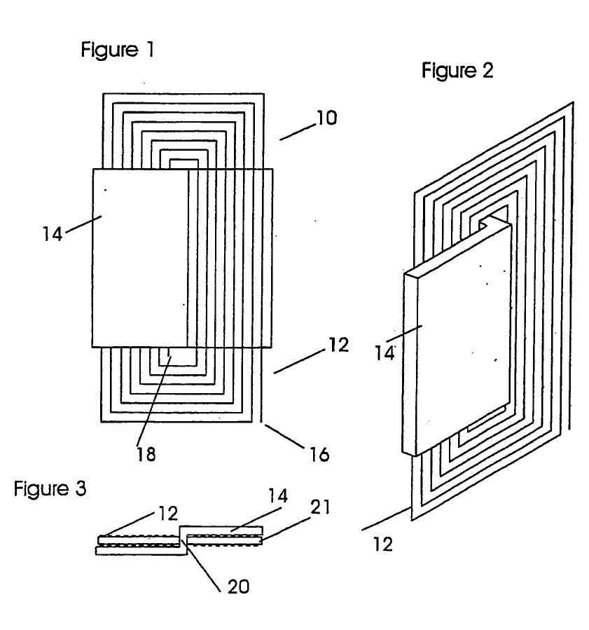

Reference is made to FIG. 1, illustrating a frontal view of a flat coil in accordance with a preferred embodiment of the present invention. The flat coil denoted by numeral 10 comprises flatly looped conductive layer 12, or strap, wound in a spiral form, preferably made from copper or other conductive material, and a core 14 made from mu-metal. The use of mu-metal as a core in flat coils in itself is considered a novel aspect by the inventor and patentable. Furthermore the design of the coil as laid down in this specification is novel and patentable. The coil has two terminals, one on either ends of the wire—an outside terminal 16 and inside terminal 18 (“outside” and “inside” referring to the relative position with respect to the wound wire). The wound wire is substantially uniplanar, preferably in the form of a printed circuit on a PCB (Printed Circuit Board), but not limited to this form. FIG. 2 illustrates a view of the coil shown in FIG. 1 provided in isometry.

FIG. 3 illustrates a sectional view of a flat coil in accordance with another preferred embodiment of the present invention. In this embodiment the conductive layer 12 is arranged spirally, on either sides of a dielectric layer 21 (for example a printed circuit board, the conductive layer printed on it on either sides).Note that the wire 12 is arranged in a flatly would thin film arrangement and a core 14 comprises a film made from mu-metal covering a wing of the loops (the film extending over the loops from the outer wind to the inter wind, and then crosses over, through the void in the center of the loops 20 and extends over the opposite wing of the loops from the other side. This arrangement renders the coil flat and thus suitable for use in applications requiring very flat coils. The conductive spiral layer 12 on either side has preferably the same numver of winds, and is arranged in a counterdirection with respect to ach other (i.e.—if the spiral on one side is in a clockwise arrangement the spiral on the other side of the board is arranged in an anti-clockwise arrangement. The spiral layers are connected at the center, at the internal ends of the spirals.

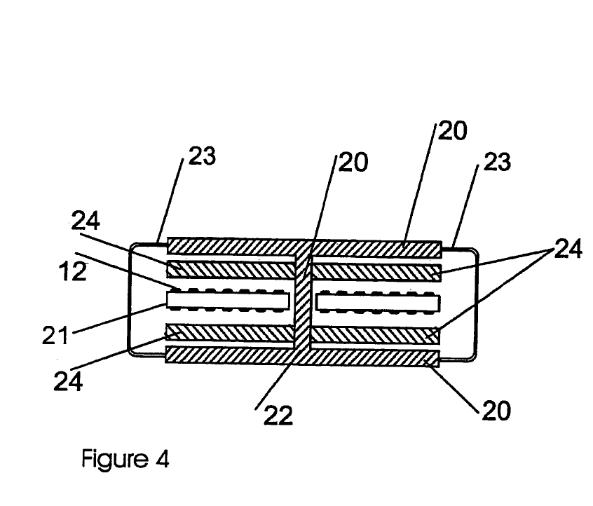

FIG. 4 illustrates another preferred embodiment of a flat coil in accordance with the present invention, in a side view. This coil too is manufactured on a double sided PCB. a spirally conductive layer 12 is provided on either sides of the board 21, preferably printed on it. A Dielectric layer 24 is laid over the conductive layer 12 on either sides of the board to serve as insulation and over the dielectric layer a mu-metal conductive layer, such as foil 20, is provided. The core layers on either sides are electrically connected via a center portion 22 passing through the board in the center of the spirals. Optionally the mu-metal layers 20 are electrically connected at their edges via conductive connections 23. Note that the layers layout shown in this figure is blown, and in fact the layers would preferably be in contact with each other—i.e.—lying one on top of the other. The spirals on either sides of the board are electrically connected at the internal ends of the spirals, and the spirals are counteroriented (as in FIG. 3).

A proposed thickness of each layer is approximately 100 microns. These layers can be manufactured using thick film technology, such as electroplating, metal-organic chemical vapor deposition (CVD).

An alternative manufacturing method is where deposition of each layer is done in a thin film technology like magnetron sputtering or similar.

The layers may also be manufactured using cut foils of mu-metal.

Mu metal (NiFe Alloys with 72-80 % Ni) is characterised as having high Permeability. The alloys in this group are currently the softest magnetic materials available. They are characterized by high initial and maximum permeability and low coercivity but have relatively low saturation polarization (0.7-0.8 T). In addition, the shape of the hysteresis loop—only in strip-wound cores—can be varied over a wide range. Magnetic cores can be produced with a rectangular loop (Z), a round loop (R) or a flat loop (F). It is emphasized that the flat coil of the present invention can be manufactured with all these types of loops, and in other arrangments too, provided the wire is spirally arranged.

Preferred alloys for a round loop are: MUMETALL, VACOPERM 100, ULTRAPERM 10, ULTRAPERM 200 and ULTRAPERM 250 (all Trademarks? You have to give information on where to get these, or instead provide the characteristics).

The principal difference between these alloys is the attainable initial and maximum permeability and the coercivity.

ULTRAPERM 250 has the highest permeability and lowest coercivity. Saturation polarization is between 0.74 and 0.8 Tesla.

Applications of these alloys include mainly miniature measurement transducers, chokes and magnetic shielding.

An example of an alloy with a flat loop is ULTRAPERM F80, having a flat loop with relatively high permeability values.

Applications of this alloy include null balance transformers for pulse current sensitive residual current devices with high response ensitivity.

In the table below the static properties of suggested materials to be used as a core material are given.

Material Permeability (μ4) Permeability (μmax) Coercivity (μ/cm)

| | | | |
|---|---|---|---|
| Mumetall | 6,0000 | 25,000 | 0,015 |
| Vacoperm | 20,000 | 35,000 | 0,01 |

Soft magnetic materials for flat coil applications are available in a wide variety of shapes and dimensions, i.e. ribbons, strips, slabs, plates, flat sections, rods/bars. Preferably when the material is pre-annealed it should undergo a final annealing.

A final heat treatment is preferably done under protective gas like hydrogen. It prevents scaling and interacts chemically with the metal, for instance removal of impurities. This is, of course, provided the protective gas itself is free of harmful impurities, above all, water vapour and oxygen content must be substantially low.

Heat treatments with dissociated ammonia (25% nitrogen, 75% hydrogen) or nitrogen are possible in some cases. However, when compared to heat treatments under hydrogen, the magnetic quality is generally lower. MUMETALL, for example, should be annealed for 2-5 hours in 1000-1,100 (° C.) and then cooled down up to 200 (° C.).

The flat coil of the present invention is very suitable for smart card applications, and in particular as a DC to DC convertor, for example for electroluminescence (EL) display.

It should be clear that the description of the embodiments and attached Figures set forth in this specification serves only for a better understanding of the invention, without limiting its scope as covered by the following claims.

It should also be clear that a person skilled in the art, after reading the present specification could make adjustments or amendments to the attached Figures and above described embodiments that would still be covered by the following claims.

1. A flat coil assembly comprising at least one electrically conductive layer arranged in a substantially uniplanar spiral arrangement of loops with a void in a center of the spiral, and a core made from mu-metal.

2. A flat coil assembly comprising at least one electrically conductive layer arranged in a substantially uniplanar spiral arrangement of loops with a void in a center of the spiral, and a core layer made from mu-metal extending on one side of the uniplanar spiral arrangement over at least a first portion of the loops from an external loop to an internal loop, crossing over, through the void in the center and extending over at least a second portion of the loops on the other side of the uniplanar spiral arrangement.

3. The flat coil assembly of claim 2, wherein the first and second portions substantially overlap.

4. The flat coil assembly of claim 2, wherein the first and second portions substantially do not overlap.

5. The flat coil assembly of claim 2 wherein there are a first and second electrically conductive layers arranged each in a substantially uniplanar spiral arrangement of loops and electrically connected at internal ends of the spirals, and having a void in a center of each of the spirals, and a core layer made from mu-metal extending on one side of the first uniplanar spiral arrangement over at least a first portion of the loops from an external loop to an internal loop, crossing over, through the voids in the center and extending over at least a second portion of the loops on the other side of the second uniplanar spiral arrangement.

6. The flat coil assembly of claim 5, wherein the electrically conductive layers are counteroriented.

7. The Flat coil assembly of claim 5, wherein each electrically conductive layer is placed on either side of a dielectric layer.

8. The flat coil assembly of claim 2, wherein the core layer and the electrically conductive layer are about 100 microns in thickness each.

9. The flat coil assembly of claim 2, wherein the electrically conductive layer is made form copper.

10. The flat coil assembly of claim 2, printed on a printed circuit board (PCB).

11. The flat coil assembly of claim 2, wherein the layers are manufactured using thick film technology, such as electroplating, metal-organic chemical vapor deposition (CVD).

12. The flat coil assembly of claim 2, wherein the layers are manufactured using thin film technology such as magnetron sputtering.

13. The flat coil assembly of claim 2, wherein the layers are manufactured using cut foils of mu-metal.

14. The flat coil assembly of claim 2, wherein the loops are rectangularly shaped.

15. The flat coil assembly of claim 2, wherein the loops are flatly shaped.

16. A flat coil assembly substantially as described in the above specification and accompanying figures.
